(19) United States
(12) Patent Application Publication
(10) Pub. No.: US 2019/0339820 A1
(43) Pub. Date: Nov. 7, 2019

(54) DISPLAYING A SUBSET OF MENU ITEMS BASED ON A PREDICTION OF THE NEXT USER-ACTIONS

(71) Applicant: Microsoft Technology Licensing, LLC, Redmond, WA (US)

(72) Inventors: Gencheng Wu, Campbell, CA (US); Lishan Yu, Cupertino, CA (US)

(21) Appl. No.: 15/969,538

(22) Filed: May 2, 2018

(51) Int. Cl. G06F 3/0482; G06F 9/451; G06F 11/34; G06F 15/18

(52) U.S. Cl. CPC G06F 3/0482; G06F 15/18; G06F 11/3438; G06F 9/451

(57) ABSTRACT

Systems, methods, and software are disclosed herein to predict and display menu items based on a prediction of the next user-actions. In an implementation, a user interface is displayed to the application. The user interface comprises menu items displayed in sub-menus of a menu. In response to an occurrence of a user-action associated with a given item of a given sub-menu of the sub-menus, a set of user-actions likely to occur next is identified based on an identity of the user-action. A subset of the menu items is then identified corresponding to the set of the user-actions likely to occur next. The subset of the menu items is then displayed in the user interface.

### TECHNICAL FIELD

Aspects of the disclosure are related to computing hardware and software technology, and in particular to display a subset of menu items based on a prediction of the next user-actions.

### TECHNICAL BACKGROUND

A graphical user interface to an application typically includes a ribbon in the form of a set of toolbars and filled with graphical buttons and other graphical control elements. The toolbars, in the form of tabs, allows a user to expose a different set of controls in a new toolbar. The graphical buttons and control elements (i.e., menu items) can be grouped by functionality and may be housed within each of the various toolbars of the ribbon. Within each tab, additional menu items may be further included in various task panes which can be hidden from view. With each additional layer of sub-tabs and hidden task panes, more and more menu items can be discovered.

For example, when inserting an image, various functionalities may be applicable to the image, such as cropping, applying a filter, etc. Many of these functionalities are not readily visible to the user without the user first clicking through various tabs, sub-tasks, drop-down menus, and opening various hidden task panes. With hundreds of menu items hidden within various layers of the menu, finding the right controls can become tedious and time consuming for a user. Hiding menu items within sub-tabs, drop-down menus, and task panes can also prevent a user from being aware that certain functionalities exist within the application.

Some software applications may allow users to customize a menu based on user preferences. Other software applications may modify floating menus based on menu items that are related in functionality. While providing these types of modified menus may reduce some time in looking through the various tabs and task panes, these modified menus are not dynamic enough to adapt to multiple different user input scenarios.

### Overview

An enhanced system, method, and software application are disclosed herein to improve the display of menu items based on a prediction of the next user-actions. In an implementation, a user interface is displayed to the application. The user interface comprises menu items displayed in sub-menus of a menu. In response to an occurrence of a user-action associated with a given item of a given sub-menu of the sub-menus, a set of user-actions likely to occur next is identified based on an identity of the user-action. A subset of the menu items is then identified corresponding to the set of the user-actions likely to occur next. The subset of the menu items is then displayed in the user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational architecture for implementing an enhanced application to provide users with a subset of menu items based on a prediction of the next user-actions.

FIG. 2 illustrates a process employed in implementations of an enhanced application to provide users with a subset of menu items based on a prediction of the next user-actions.

FIG. 3 illustrates an operational architecture in an implementation of an enhanced application to provide users with a subset of menu items based on a prediction of the next user-actions.

FIG. 4 illustrates a sequence diagram in an implementation of an enhanced application to provide users with a subset of menu items based on a prediction of the next user-actions.

FIG. 5 illustrates an exemplary scenario in an implementation of an enhanced application to provide users with a subset of menu items based on a prediction of the next user-actions.

FIG. 6 illustrates an alternative exemplary scenario in an implementation of an enhanced application to provide users with a subset of menu items based on a prediction of the next user-actions.

FIG. 7 illustrates a mapping table which may be used in an implementation of the enhanced application to provide users with a subset of menu items based on a prediction of the next user-actions.

FIG. 8 illustrates a process employed in implementations of an enhanced application to provide users with a subset of menu items based on a prediction of the next user-actions.

FIG. 9 illustrates a computing system suitable for implementing the technology disclosed herein, including any of the architectures, processes, operational scenarios, and operational sequences illustrated in the Figures and discussed below in the Technical Description.

### TECHNICAL DESCRIPTION

Examples of the present disclosure describe an application for improving the display of menu items based on a prediction of the next user-actions. In an implementation, a user interface is displayed to the application. The user interface comprises menu items displayed in sub-menus of a menu. In response to an occurrence of a user-action associated with a given item of a given sub-menu of the sub-menus, a set of user-actions likely to occur next is identified based on an identity of the user-action. A subset of the menu items is then identified corresponding to the set of the user-actions likely to occur next. The subset of the menu items is then displayed in the user interface.

A technical effect that may be appreciated from the present discussion is the increased efficiency in discovering the next possible functionalities which will be used by the user (e.g., when hundreds of functionalities are available, but the user will only likely use a select few) and providing a display of only a subset of the menu items which correspond to the possible functionalities. The application described herein also improves efficiency by showing the user commonly used menu items which were taken by other users in response to the previous action taken by the user. This allows the user to dynamically view controls in a recommended menu that the user may not have been aware of or had thought would be useful to perform in their next action.

Further examples herein describe that the subset of the menu items is displayed in a recommendation menu that differs from the sub-menus of the menu. For example, an additional tab may be included in the menu which includes the subset of menu items. These menu items may be compiled from the hundreds of menu items included in each of the other tabs. In other examples, each menu item of the subset of the menu items is displayed in an associated sub-menu of the menu. For example, each tab may only display the menu items which were identified to be included in the subset of menu items. Therefore, a user selecting the tab would easily find the most menu items based on a prediction of the next user-actions which would be selected from that tab.

In some implementations, the set of user-actions likely to occur next are identified by determining user-actions taken by other users in response to the occurrence of the user-action associated with the given item of the given sub-menu of the sub-menus. In this implementation, the next user-action would be predicted based on what menu items most other users selected in response to the previously selected menu item. The actions of the other users may be collected and recorded to be later analyzed when predicting a user's most likely subsequent action. In other implementations, the set of user-actions likely to occur next are identified by determining user-actions taken by other users in response to the occurrence of the user-action associated with the given item of the given sub-menu of the sub-menus. In this implementation, the previous actions taken in response to the recent action are collected and recorded. The record is then evaluated to identify the most menu items based on a prediction of the next user-actions to be selected in response to the recent user-action.

In yet another example, the set of user-actions likely to occur next is identified by determining a sequence of identified user-actions and comparing the sequence of identified user-actions to previously performed sequences of identified user-actions. In some scenarios, to identify the subset of the menu items corresponding to the set of the user-actions likely to occur next, the user-actions likely to occur next are mapped to the subset of menu items using a table associating each user-action to a menu item. In other scenarios, user-actions associated with given items of given sub-menus are tracked in a cloud-based data repository to be ingested by a machine learning system to identify the set of user-actions likely to occur next based on the identity of the user-action.

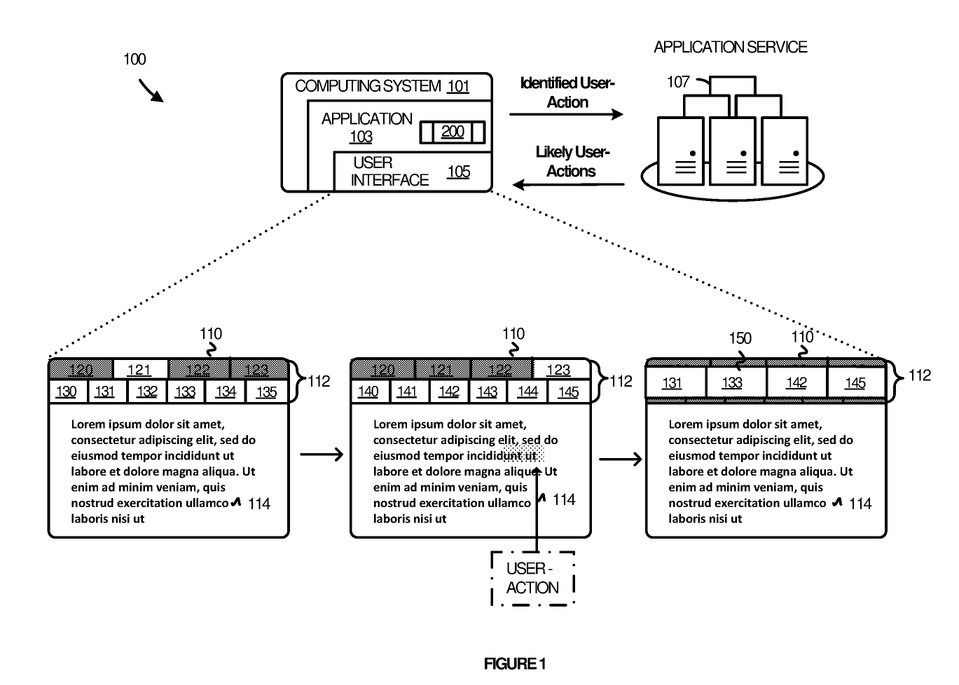

Referring to the drawings, FIG. 1 illustrates an exemplary operational architecture 100 related to processing operations for management of an exemplary enhanced system with which aspects of the present disclosure may be practiced. Operational environment 100 includes computing system 101 and application service 107. Computing system 101 employs a menu item identification process 200 in the context of displaying menus in user interface 105 in a computing environment. User interface 105 displays menu items 130-135 in sub-menus 120-123 of menu 112 produced by application 103. View 110 is representative of a view that may be produced by application 103.

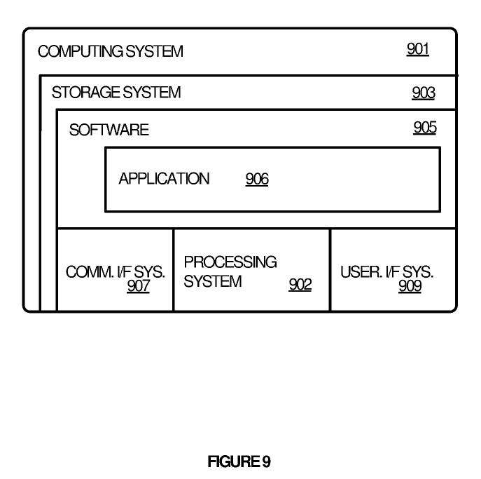

Computing system 101 is representative of any device capable of running an application natively or in the context of a web browser, streaming an application, or executing an application in any other manner Examples of computing system 101 include, but are not limited to, personal computers, mobile phones, tablet computers, desktop computers, laptop computers, wearable computing devices, or any other form factor, including any combination of computers or variations thereof. Computing system 101 may include various hardware and software elements in a supporting architecture suitable for performing identification process 200. One such representative architecture is illustrated in FIG. 9 with respect to computing system 901.

Application 103 is representative of any software application or application component capable of identifying subsets of menu items corresponding to a set of likely user-actions to occur next based on a user-action in accordance with the processes described herein. Examples of application 103 include, but are not limited to, presentation applications, diagramming applications, computer-aided design applications, productivity applications (e.g. word processors or spreadsheet applications), and any other type of combination or variation thereof. Application 103 may be implemented as a natively installed and executed application, a web application hosted in the context of a browser, a streamed or streaming application, a mobile application, or any variation or combination thereof. It should be understood that program instructions executed in furtherance of application 103 may be offloaded in whole or in part to an operating system or additional application services operating on a remote computing system.

View 110 is representative of a view that may be produced by a drafting and authoring application, such as Word® from Microsoft®, although the dynamics illustrated in FIG. 1 with respect to view 110 may apply to any other suitable application. An end user may interface with application 103 to produce text, charts, graphs, diagrams, basic layout drawings, or any other type of content component displayed on user interface 105. View 110 may display content, such as a text document, presentation, slide show, spreadsheet, diagram, etc. The user may interface with application 103 using an input instrument such as a stylus, mouse device, keyboard, touch gesture, as well as any other suitable input device.

Application service 107 is representative of any device capable of running an application natively or in the context of a web browser, streaming an application, or executing an application in any other manner. Application service 107 may include various hardware and software elements in a supporting architecture suitable for interacting with application 103. In particular, application service 107 may be capable of tracking user-actions made by all users interacting with application service 107, receive queries from software applications (running natively or streaming) requesting user-actions likely to occur next based on an identified user-action, and provide the software applications with the user-actions likely to occur next. Application service 107 may include or further communicate with data repositories, recommendation engines, etc. to track previously performed user-actions and identify user-actions likely to occur next.

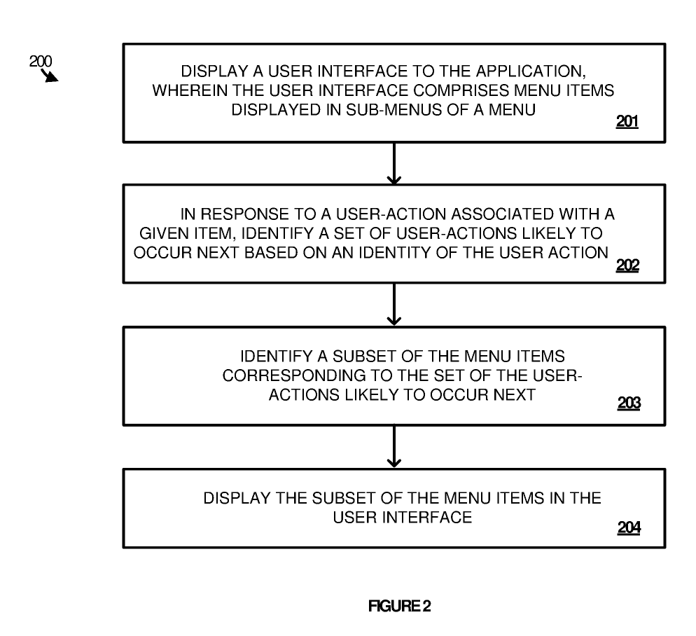

More particularly, FIG. 2 illustrates menu item identification process 200 which, as mentioned, may be employed by application 103 to provide a display of a subset of menu items as described herein. Some or all of the steps of menu item identification process 200 may be implemented in program instructions in the context of a component or components of the application used to carry out the identification and display feature. The program instructions direct application 103 to operate as follows, referring parenthetically to the steps in FIG. 2 in the context of FIG. 1.

In operation, application 103 displays user interface 105 to application 103 (step 201). User interface 105 comprises menu items 130-135 displayed in sub-menus 120-123 of menu 112. Menu 112 may be presented to allow a user to perform functionalities on content item 114. Content item 114 may be a presentation, canvas or diagram, productivity document (e.g. word document or spreadsheet), audio file, video file, and any other type of combination or variation thereof. Each of sub-menus 120-123 of menu 112 may comprise a tab in a ribbon. Each tab may be associated with a functionality type, such as inserting, drawing, reviewing, etc.

Additionally, each of sub-menus 120-123 may include additional sub-menus, drop-down menus, hidden task panes, etc. Each layer of sub-menus 120-123 may contain various menu items. For example, sub-menu 121 includes menu items 130-135. However, other sub-menus may include different sets of menu items and additional layers of sub-menus which each may include additional menu items. For example, when sub-menu 123 is selected, menu items 140-145 are displayed.

In a next operation, in response to an occurrence of a user-action associated with a given item of given sub-menu 123 of the sub-menus, application 103 identifies a set of user-actions likely to occur next based on an identity of the user-action (step 202). The user-action may be a selection of one of sub-menus or one of the menu items. The user-action may also be an action performed on content item 114 or a portion of content item 114. For example, a user may select a portion of text within content item 114. Application 103 may receive the user-action using an input instrument such as a stylus, mouse device, keyboard, touch gesture, as well as any other suitable input device.

Application 103 may identify the user-actions likely to occur next by querying application service 107 for the predicted next user-action based on the identified user-action performed on the given item. Application 103 may then receive a recommendation from application service 107 indicating the user-actions likely to occur next. For example, Application service 107 may track the user-action in a record or database for later analysis. It should be noted that in other scenarios, the record may be maintained in the native applications (such as application 103), in another cloud-based application service, or in some other database which tracks and retrieves historical user-actions. The record may further maintain historical user-actions for a plurality of users interacting with application service 107.

The user-actions likely to occur may be selected by querying a record of previous user-actions. In some implementations, the set of user-actions likely to occur next are identified by determining user-actions taken by other users in response to the occurrence of the user-action associated with the given item of the given sub-menu of the sub-menus. In this implementation, the next user-action would be predicted based on what menu items most other users selected in response to the previously selected menu item. In other implementations, the set of user-actions likely to occur next are identified by determining user-actions taken by other users in response to the occurrence of the user-action associated with the given item of the given sub-menu of the sub-menus. In this implementation, the previous actions taken in response to the recent action are collected and recorded. The record is then evaluated to identify the most menu items based on a prediction of the next user-actions to be selected in response to the recent user-action.

In yet another example, the set of user-actions likely to occur next is identified by determining a sequence of identified user-actions taken by the current user and comparing the sequence of identified user-actions to previously performed sequences of identified user-actions. In other scenarios, user-actions associated with given items of given sub-menus are tracked in a cloud-based data repository to be ingested by a machine learning system to identify the set of user-actions likely to occur next based on the identity of the user-action.

In a next operation, application 103 identifies a subset of the menu items 150 corresponding to the set of the user-actions likely to occur next (step 203). The subset of the menu items 150 may be determined based on a top number of menu items likely to be selected next. For example, the top four menu items likely to be selected out of the hundreds of possible menu items available may be identified, such as menu items 131, 133, 142, and 145.

In other scenarios, the subset of menu items 150 may be selected based on any menu item that has a selection probability above a specified confidence level. For example, in response to a user-action, application 103 may determine that any menu item that is associated with an 80% likelihood of being selected next should be included in the subset of menu items 150. In some scenarios, to identify the subset of the menu items 150 corresponding to the set of the user-actions likely to occur next, the user-actions likely to occur next are mapped to the subset of menu items 150 using a table associating each user-action to a menu item.

In a final operation, application 103 displays the subset of the menu items 150 in user interface 105 (step 204). In some examples, the subset of the menu items 150 is displayed in a recommendation menu that differs from the sub-menus of the menu. For example, an additional tab may be included in menu 112 which includes the subset of menu items 150. These menu items may be compiled from the hundreds of menu items included in each of the other tabs. In other examples, each menu item of the subset of the menu items 150 is displayed in an associated sub-menu of menu 112. For example, each tab may only display the menu items which were identified to be included in subset of menu items 150. Therefore, a user selecting the tab would easily find the most likely menu items based on a prediction of the next user-actions which would be selected from that tab.

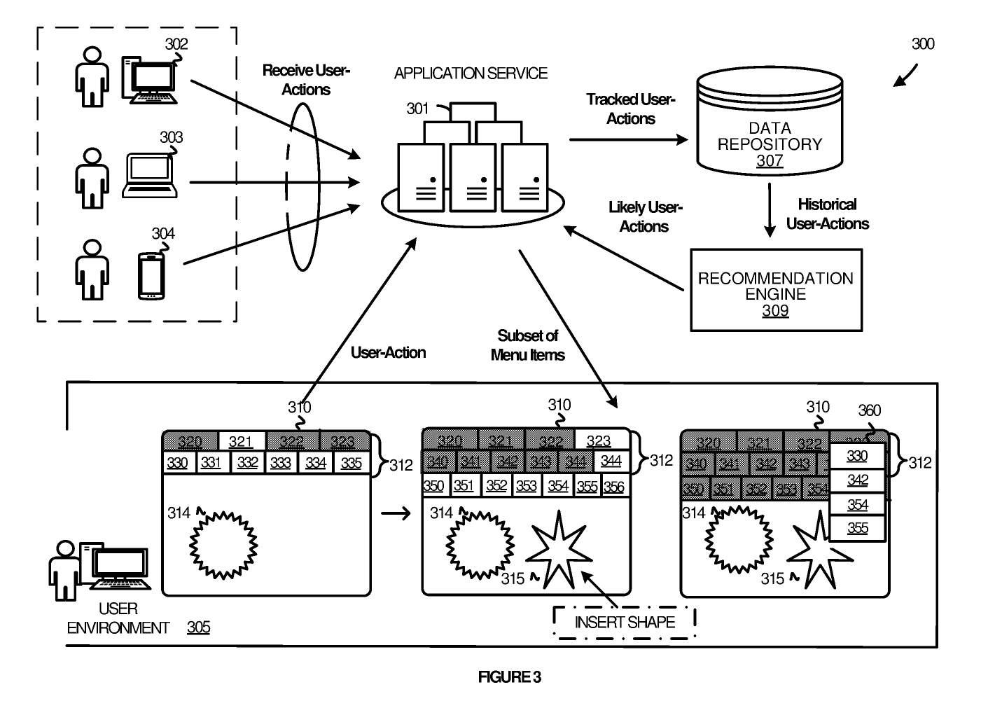

FIG. 3 illustrates operational architecture in an implementation of an enhanced application to provide users with a subset of menu items based on a prediction of the next user-actions. FIG. 3 illustrates an operational scenario 300 that relates to what occurs when a machine learning engine provides predicted user-actions and an application service identifies a subset of menu items. Operational scenario 300 includes application service 301, user interface 310 in user environment 305, and other users interacting with application 301 using user devices 302-304. User interface 310 displays menu 312. Menu 312 includes menu items 330-335 in sub-menus 320-323. View further includes shape 314 and shape 315.

Operational scenario 300 also includes data repository 307 to collect user-action sequences and maintain a record of the sequences. The historical user-actions may be communicated to recommendation engine 309. Recommendation engine 309 may include an application or cloud-based platform which generates recommendations, such as recommendation application protocol interfaces (APIs) using machine learning computational resources. An example of recommendation engine 309 may be Azure® from Microsoft®. Recommendation engine 309 trains models and services recommendations to application service 301. In the present implementation, recommendation engine 309 determines which user-actions are likely to occur next based on the identified user-action performed and the historical user-action sequences recorded in data repository 307.

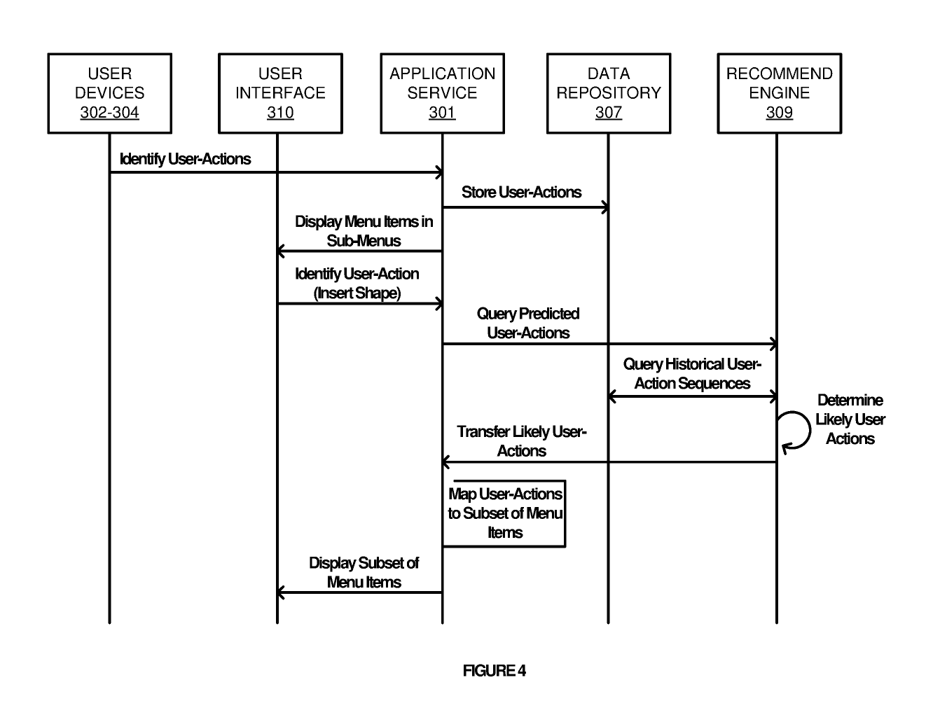

FIG. 4 illustrates a sequence diagram in an implementation of an enhanced application to provide users with a subset of menu items based on a prediction of the next user-actions. The sequence diagram of FIG. 4 illustrates operations performed in accordance with the components previously described in operational scenario 300. In a first operation, application service 301 interacts with users and tracks user-actions performed by users using user devices 302-304. Application service 301 then stores the user-actions in data repository 307. It should be noted that the user-actions may further track the sequence of user-actions performed. The user-actions may be tracked for a particular user, a particular user type, or for all users interacting with application service 301.

In a next operation, application service 301 displays menu items 330-335 in sub-menus 320-323 of menu 312 in user interface 310. In response, application service 301 receives a user-action associated with a given item of a given sub-menu of the sub-menus. In this example, application service 301 identifies the user-action to be an insertion of shape 315 using one or menu items 350-356 of drop-down menu 344 within sub-menu 323. In response to determining that the user-action was an insertion of shape 315, application service 301 queries recommendation engine 309 for user-actions that are likely to occur in response to the insertion of a shape.

At this point in the process, recommendation engine 309 queries data repository 307 for historical user-actions which include the identified user-action in their sequence. Although recommendation engine 309 does not reside internally in application service 301, it should be understood that both data repository 307 and recommendation engine 309 may be included in application service 301. It should also be understood that data repository 307 and recommendation engine 309 may reside in the same application service, data server, or a remote computing system.

Referring still to FIG. 4, in response to receiving the historical user-action sequences from data repository 307, recommendation engine 309 may determine a set of user-actions likely to occur. The user-actions may be determined to likely occur if they meet a minimum confidence level requirement. The user-actions may also be determined to likely occur if they are included in the top number of user-actions performed after the identified user-action (or sequence of user-actions) were performed. Recommendation engine 309 may determine the user-actions likely to occur by comparing the identified user-action to the previous user-actions performed by the same user, a group of users with a similar status type, or by all users interacting with application service 301.

In a next operation, application service 301 receives the set of user-actions which have been identified as likely to occur next. At this point, application service 301 queries an internal table associating user-actions to each of the menu items to determine subset of menu items 360. In this example, the subset of menu items 360 includes menu items 330, 342, 354, 356. The table may map each of the user-actions on a one-to-one basis to each menu item. Alternatively, the table may map multiple user-actions to one menu item, and vice versa.

In response to identifying each of the menu items to be included in subset of menu items 360, application service 301 may display subset of menu items 360 to the user in user interface 310. It should be noted that subset of menu items 360 may be displayed in a new sub-menu which incorporates each of menu items 330, 342, 354, and 355 from the other sub-menus 320-325 which were included in subset of menu items 360. However, as illustrated in FIG. 3, subset of menu items 360 is displayed in a floating menu.

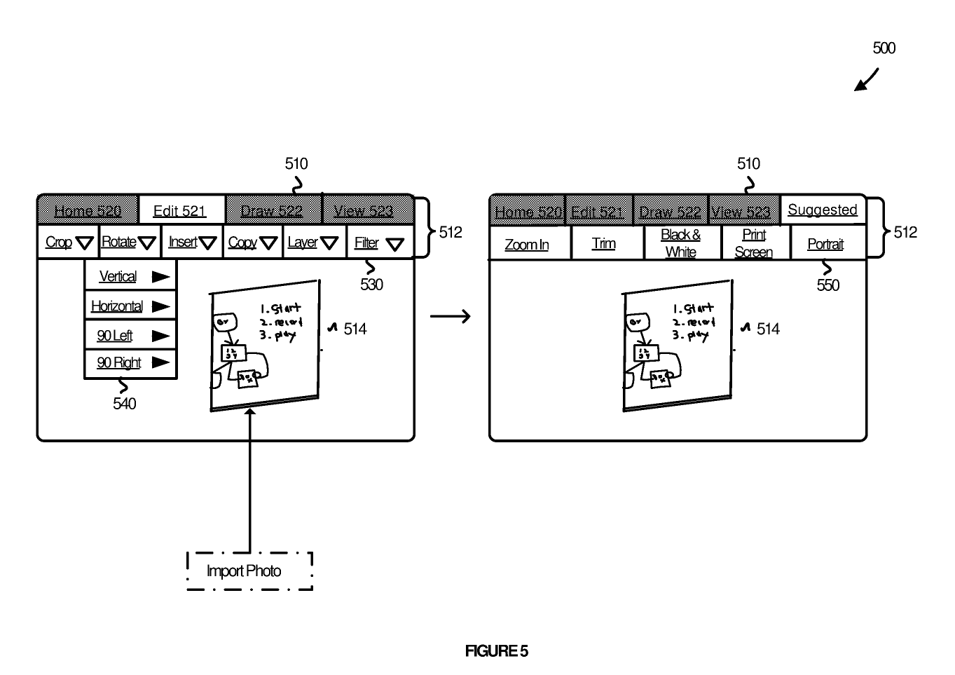

FIG. 5 illustrates an exemplary scenario in an implementation of an enhanced application to provide users with a subset of menu items based on a prediction of the next user-actions. As illustrated in FIG. 5, user interface 510 displays menu 512. Menu 512 includes various tabs, such as Home 520, Edit 521, Draw 522, View 523, etc. Within each tab is a series of sub-tabs 530, such as Crop, Rotate, Insert, etc. Some or all of sub-tabs 530 may additionally include drop-down menus 540 with additional menu items. In this example scenario, photo 514 is imported and displayed on user interface 510. In response to the importation of photo 514, a set of user-actions that are likely to occur are identified.

Based on the identified user-actions that are likely to occur next, subset of menu items 550 is identified and displayed in user interface 510. For example, the menu items corresponding to the most likely user-actions to occur are determined to be Zoom-In, Trim, Black-White filtering, etc. These items are displayed in a suggested tab. It should be noted that each of the menu items included in subset of menu items 550 were previously displayed across multiple tabs 520-523, sub-tabs 530, drop-down menus 540, etc. This allows a user to have faster and easier access to menu items corresponding to a user-action the user will likely take.

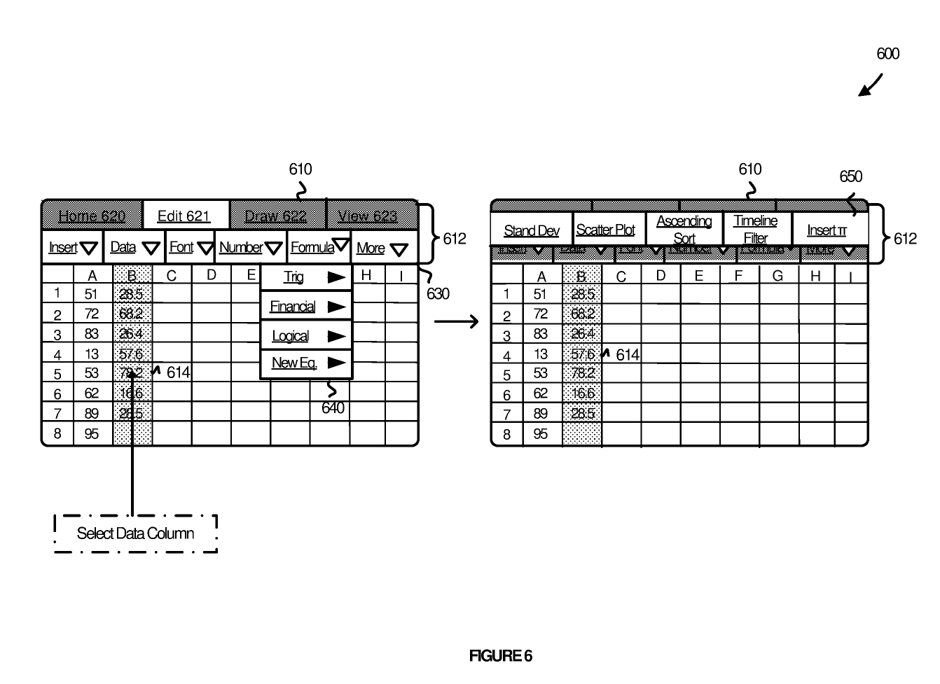

FIG. 6 illustrates an alternative exemplary scenario in an implementation of an enhanced application to provide users with a subset of menu items based on a prediction of the next user-actions. As illustrated in FIG. 6, user interface 610 displays menu 612. Menu 612 includes various tabs, such as Home 620, Edit 621, Draw 622, View 623, etc. Within each tab is are sub-tabs, such as sub-tabs 630 including Insert, Data, Font, etc. Some or all of sub-tabs 630 may additionally include drop-down menus 640 with additional menu items. In this example scenario, column of data 614 is selected in a spreadsheet displayed on user interface 610. In response to the selection of column of data 614, a set of user-actions that are likely to occur are identified.

Based on the identified user-actions that are likely to occur next, subset of menu items 650 is identified and displayed in user interface 610. For example, the menu items corresponding to the most likely user-actions to occur are determined to be the standard deviation, draw a scatter plot, sort the data in ascending order, etc. These items are displayed in a floating tab. It should be noted that each of the menu items previously displayed across multiple tabs 620-623, sub-tabs 630, drop-down menus 640, additional task panes, etc. are hidden from view but may be accessed if the actual next user-action is not included in the floating menu comprising subset of menu items 650.

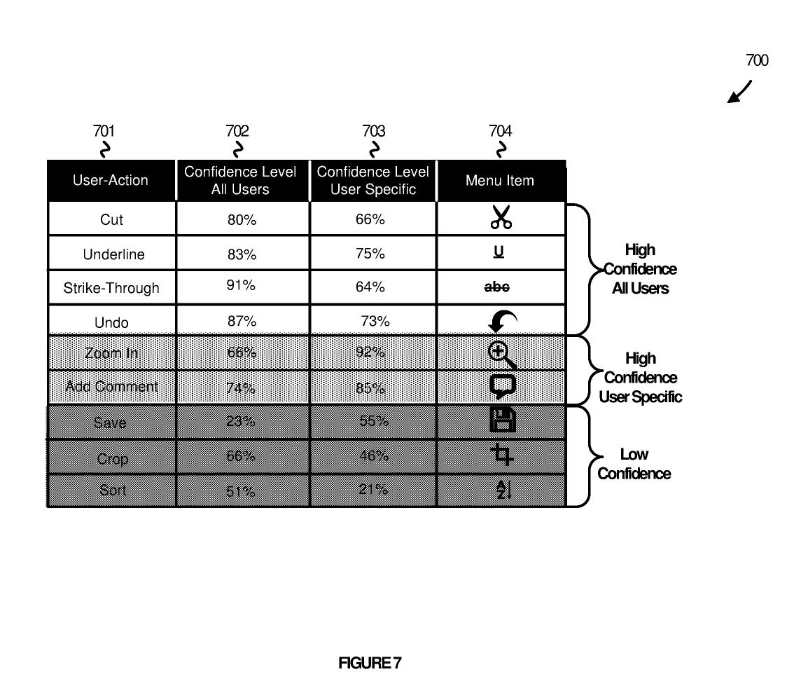

FIG. 7 illustrates mapping table 700, which is representative of a table to identify user-actions with high confidence levels and map those user-actions to menu items which may be displayed in a user interface. As illustrated in FIG. 7, mapping table 700 includes columns 701-704. In particular, column 701 includes the user-action likely to occur next. The user-actions in this example may be a cut, an underline, strike-though, etc. It should be noted that the user-actions likely to occur next and/or the confidence levels may be received from a recommendation engine.

Each of the next possible user-actions may be determined based on which actions are available to the user based on the user's current version of the application. Each of the next possible user-actions may also be determined based on any user-action taken by other users previously which are available in at least one version of the application. In other scenarios, the next possible user-actions may be determined based on the device the user is currently running the application on. For example, if a user is not using a device that has touch capabilities, user-actions related to drawing using a touch-input device would not be included in the set of user-actions likely to occur next. It should also be noted that the next possible user-actions may also be determined based on the user's current settings for the application or content item. For example, if a user has indicated that the file is “read only”, any user-action related to editing the document would not be included in the user-actions.

Still referring to FIG. 7, column 702 includes confidence levels for each user-action likely to occur next based on previous user-actions performed by all users who have interacted with the application. For example, if a user has selected a portion of data, there is an 80% confidence level that the user may cut the portion of text next based on previous user-actions of all users. On the other hand, there may only be a 51% confidence level that the user will likely sort the data based on the previous user-actions of all users.

In a next column, column 703 indicates the confidence level for each user-action likely to occur based on previous user-actions performed by the specific user who is currently interacting with the application. For example, a user may often zoom-in on a portion of data after selecting the portion of data. Where the confidence level that a user would zoom-in based on the previous user-actions of all users is only 66%, for the specific user the confidence level may be 92%.

Next, column 704 indicates the menu item that is mapped to each of the user-actions likely to occur. Although FIG. 7 indicates that each user-action may be mapped to a menu item, it should be noted that in other implementations each user-action may not be directly mapped to only one menu item, and vice versa. For example, it may be determined that the user will likely perform a change to the font of a portion of text in response to highlighting the portion of text. In this example, several menu items may be mapped to the user-action of changing the font, such as various font sizes and font styles.

Referring again to FIG. 7, each user-action likely to occur next has been categorized as having a high confidence level based on the previous user-actions of all users, a high confidence level based on the previous user-actions of the specific user, or a low confidence level of likely be selected based on both previous user-actions taken by all users and previous-user actions taken by the specific user. Additionally, the menu items for each user-action has been mapped. Based on the indicated results, at least a portion of the menu items associated with a high confidence level are displayed to a user. For example, every menu item that is associated with a high confidence level based on the previous actions taken by the specific user may be displayed.

In other scenarios, every menu item that is associated with a high confidence level based on the previous user-actions performed by all users may be displayed to the user. In other scenarios, only menu items associated with a high confidence level by the previous user-actions taken by both the specific user and all of the users are displayed. In some implementations, a weighted average of each confidence level associated with each menu item is determined to select which menu items are to be displayed on the user interface.

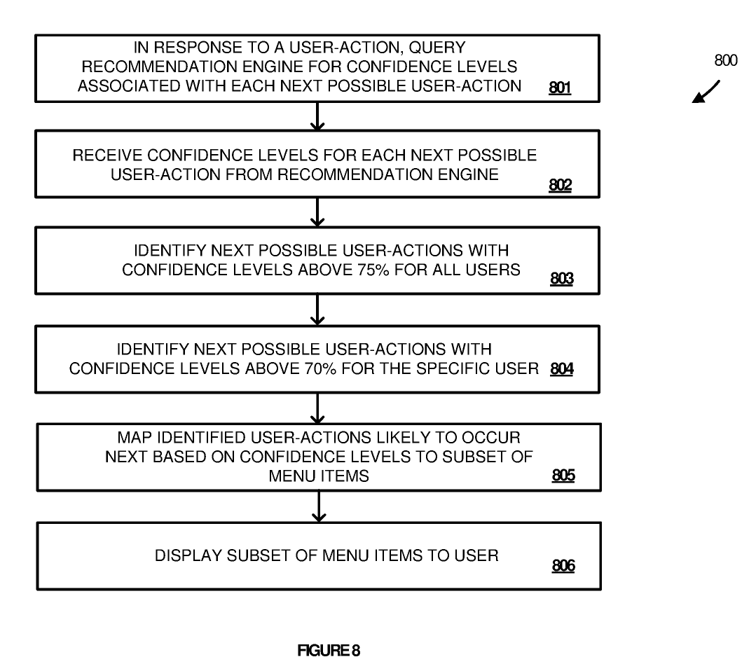

FIG. 8 illustrates a flow diagram which may be employed by an application service to provide a display of a subset of menu items as described herein. Some or all of the steps of process 800 may be implemented in program instructions in the context of a component or components of the application used to carry out the identification and display feature. The program instructions direct an application service to operate as follows, referring parenthetically to the steps in FIG. 8.

In a first operation, in response to a user-action taken with respect to a given item, the application service queries a recommendation engine for confidence levels associated with each next possible user-action (step 801). The recommendation engine may utilize machine learning to process previous sequences of user-actions and predict a confidence level that each of the possible user-actions available to the user may occur next. The data indicating the previous user-actions may be stored in the recommendation engine, stored on a data repository which may be queried by the recommendation engine, or may be provided to the recommendation engine by the application service itself.

In a next operation, the application receives confidence levels for each next possible user-action from the recommendation engine (step 802). The confidence levels may be determine based on the previous user-actions performed by all users in response to the identified user-action. The confidence levels may also be determined based on the previous user-actions performed by the specific user in response to the identified user-action. In other scenarios, the confidence levels may be determined based on the previous user-actions performed by a group of users who are associated with the specific user. For example, if the specific user is a student, recommendation engine may only determine confidence levels for previous user-actions performed by student users who have interacted with the application service.

In response to receiving the confidence levels for each of the next possible user-actions, the application identifies which of the next possible user-actions is associated with a confidence level of 75% or above based on the previous user-actions taken by all users who interact with the application service (step 803). The application service also identifies which of the next possible user-actions is associated with a confidence level of 70% or above based on the previous user-actions taken by the specific user interacting with the application service (step 804).

Next, the application service maps the identified user-actions likely to occur next based on the confidence levels of all of the users and the specific user to a subset of menu items (step 805). The identified user-actions likely to occur next may be selected based on one, both, or a weighted average of the confidence levels associated with each possible user-action. The user-actions may be mapped to the menu items using a table, such as mapping table 700 described in FIG. 7.

The subset of menu items is then displayed to the user in the user interface (step 806). The subset of menu items may be displayed in a recommendation tab. In other scenarios, the menu items may be displayed in a floating menu. It should be noted that in some implementations, the menu items may be displayed in each of the tabs in which the menu item was originally displayed. However, all menu items in each of the tabs that are not included in the subset of menu items may be hidden from view to the user.

FIG. 9 illustrates computing system 901, which is representative of any system or visual representation of systems in which the various applications, services, scenarios, and processes disclosed herein may be implemented. Examples of computing system 901 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. Software 905 includes process 906, which is representative of the processes discussed with respect to the preceding FIGS. 1-8, including menu item identification process 200. When executed by processing system 902 to enhance an application, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device, but may also be distributed across multiple processing devices or sub-systems that cooperate in executing program instructions. Examples of processing system 902 include general purpose central processing units, graphical processing unites, application specific processors, and logic devices, as well as any other type of processing device, combination, or variation.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. Storage system 903 may be implemented as a single storage device, but may also be implemented across multiple storage devices or sub-systems co-located or distributed relative to each other. Storage system 903 may comprise additional elements, such as a controller, capable of communicating with processing system 902 or possibly other systems.

Software 905 may be implemented in program instructions and among other functions may, when executed by processing system 902, direct processing system 902 to operate as described with respect to the various operational scenarios, sequences, and processes illustrated herein. Software 905 may include program instructions for implementing menu item identification process 200.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtual machine software, or other application software, in addition to or that include process 906. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system to enhance a service for displaying menu items based on a prediction of the next user-actions in a user interface. Indeed, encoding software 905 on storage system 903 may transform the physical structure of storage system 903. The specific transformation of the physical structure may depend on various factors in different implementations of this description. Such factors may include, but are not limited to, the technology used to implement the storage media of storage system 903 and whether the computer-storage media are characterized as primary or secondary storage, as well as other factors.

If the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 909 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 909. In some cases, the input and output devices may be combined in a single device, such as a display capable of displaying images and receiving touch gestures. The aforementioned user input and output devices are well known in the art and need not be discussed at length here. User interface system 909 may also include associated user interface software executable by processing system 902 in support of the various user input and output devices discussed above.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here.

In any of the aforementioned examples in which data, content, or any other type of information is exchanged, the exchange of information may occur in accordance with any of a variety of protocols, including FTP (file transfer protocol), HTTP (hypertext transfer protocol), HTTPS, REST (representational state transfer), WebSocket, DOM (Document Object Model), HTML (hypertext markup language), CSS (cascading style sheets), HTMLS, XML (extensible markup language), JavaScript, JSON (JavaScript Object Notation), and AJAX (Asynchronous JavaScript and XML), as well as any other suitable protocol, variation, or combination thereof.

Certain inventive aspects may be appreciated from the foregoing disclosure, of which the following are various examples.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. Those skilled in the art will understand and appreciate that a method could alternatively be represented as a series of interrelated states or events, such as in a state diagram. Moreover, not all acts illustrated in a methodology may be required for a novel implementation.

### Example 1

A computer apparatus comprising: one or more computer readable storage media; one or more processors operatively coupled with the one or more computer readable storage media; and an application comprising program instructions stored on the one or more computer readable storage media that, when read and executed by the one or more processors, direct the one or more processors to at least: display a user interface to the application, wherein the user interface comprises menu items displayed in sub-menus of a menu; in response to an occurrence of a user-action associated with a given item of a given sub-menu of the sub-menus, identify a set of user-actions likely to occur next based on an identity of the user-action; identify a subset of the menu items corresponding to the set of the user-actions likely to occur next; and display the subset of the menu items in the user interface.

### Example 2

The computer apparatus of Example 1 wherein the subset of the menu items is displayed in a recommendation menu that differs from the sub-menus of the menu.

### Example 3

The computer apparatus of Examples 1-2 wherein each menu item of the subset of the menu items is displayed in an associated sub-menu of the menu.

### Example 4

The computer apparatus of Examples 1-3 wherein to identify the set of user-actions likely to occur next based on the identity of the user-action, the program instructions direct the one or more processors to identify user-actions previously taken by other users in response to the occurrence of the user-action associated with the given item of the given sub-menu of the sub-menus.

### Example 5

The computer apparatus of Examples 1-4 wherein to identify the set of user-actions likely to occur next based on the identity of the user-action, the program instructions direct the one or more processors to identify user-actions previously taken by the user in response to the occurrence of the user-action associated with the given item of the given sub-menu of the sub-menus.

### Example 6

The computer apparatus of Examples 1-5 wherein to identify the set of user-actions likely to occur next based on the identity of the user-action, the program instructions direct the one or more processors to identify the set of user-actions likely to occur next based on a sequence of identified user-actions.

### Example 7

The computer apparatus of Examples 1-6 wherein to identify the subset of the menu items corresponding to the set of the user-actions likely to occur next, the program instructions direct the one or more processors to map the user-actions likely to occur next to the subset of menu items using a table associating each user-action to a menu item.

### Example 8

The computer apparatus of Examples 1-7 wherein the program instructions further direct the one or more processors to track user-actions associated with given items of given sub-menus in a cloud-based data repository to be ingested by a machine learning system to identify the set of user-actions likely to occur next based on the identity of the user-action.

### Example 9

A method comprising: displaying a user interface to the application, wherein the user interface comprises menu items displayed in sub-menus of a menu; in response to an occurrence of a user-action associated with a given item of a given sub-menu of the sub-menus, identifying a set of user-actions likely to occur next based on an identity of the user-action; identifying a subset of the menu items corresponding to the set of the user-actions likely to occur next; and displaying the subset of the menu items in the user interface.

### Example 10

The method of Example 9 wherein the subset of the menu items is displayed in a recommendation menu that differs from the sub-menus of the menu.

### Example 11

The method of Examples 9-10 wherein each menu item of the subset of the menu items is displayed in an associated sub-menu of the menu.

### Example 12

The method of Examples 9-11 wherein to identify the set of user-actions likely to occur next based on the identity of the user-action, the program instructions direct the one or more processors to identify user-actions previously taken by other users in response to the occurrence of the user-action associated with the given item of the given sub-menu of the sub-menus.

### Example 13

The method of Examples 9-12 wherein to identify the set of user-actions likely to occur next based on the identity of the user-action, the program instructions direct the one or more processors to identify user-actions previously taken by the user in response to the occurrence of the user-action associated with the given item of the given sub-menu of the sub-menus.

### Example 14

The method of Examples 9-13 wherein to identify the set of user-actions likely to occur next based on the identity of the user-action, the program instructions direct the one or more processors to identify the set of user-actions likely to occur next based on a sequence of identified user-actions.

### Example 15

The method of Examples 9-14 wherein to identify the subset of the menu items corresponding to the set of the user-actions likely to occur next, the program instructions direct the one or more processors to map the user-actions likely to occur next to the subset of menu items using a table associating each user-action to a menu item.

### Example 16

The method of Examples 9-15 wherein the program instructions direct the one or more processors to track user-actions associated with given items of given sub-menus in a cloud-based data repository to be ingested by a machine learning system to identify the set of user-actions likely to occur next based on the identity of the user-action.

### Example 17

One or more computer readable storage media having program instructions stored thereon, wherein the program instructions, when executed by a processing system, direct the processing system to at least: display a user interface to the application, wherein the user interface comprises menu items displayed in sub-menus of a menu; in response to an occurrence of a user-action associated with a given item of a given sub-menu of the sub-menus, identify a set of user-actions likely to occur next based on an identity of the user-action; identify a subset of the menu items corresponding to the set of the user-actions likely to occur next; and display the subset of the menu items in the user interface.

### Example 18

The one or more computer readable storage media of Example 17 wherein the subset of the menu items is displayed in a recommendation menu that differs from the sub-menus of the menu.

### Example 19

The one or more computer readable storage media of Examples 17-18 wherein to identify the set of user-actions likely to occur next based on the identity of the user-action, the program instructions direct the one or more processors to identify user-actions taken by at least one of the user or other users in response to the occurrence of the user-action associated with the given item of the given sub-menu of the sub-menus.

### Example 20

The one or more computer readable storage media of Examples 17-19 the program instructions direct the one or more processors to track user-actions associated with given items of given sub-menus in a cloud-based data repository to be ingested by a machine learning system to identify the set of user-actions likely to occur next based on the identity of the user-action.

What is claimed is:

1. A computer apparatus comprising:
one or more computer readable storage media;
one or more processors operatively coupled with the one or more computer readable storage media; and
an application comprising program instructions stored on the one or more computer readable storage media that, when read and executed by the one or more processors, direct the one or more processors to at least:
display a user interface to the application, wherein the user interface comprises menu items displayed in sub-menus of a menu;
in response to an occurrence of a user-action associated with a given item of a given sub-menu of the sub-menus, identify a set of user-actions likely to occur next based on an identity of the user-action;
identify a subset of the menu items corresponding to the set of the user-actions likely to occur next; and
display the subset of the menu items in the user interface.

2. The computer apparatus of claim 1 wherein the subset of the menu items is displayed in a recommendation menu that differs from the sub-menus of the menu.

3. The computer apparatus of claim 1 wherein each menu item of the subset of the menu items is displayed in an associated sub-menu of the menu.

4. The computer apparatus of claim 1 wherein to identify the set of user-actions likely to occur next based on the identity of the user-action, the program instructions direct the one or more processors to identify user-actions previously taken by other users in response to the occurrence of the user-action associated with the given item of the given sub-menu of the sub-menus.

5. The computer apparatus of claim 1 wherein to identify the set of user-actions likely to occur next based on the identity of the user-action, the program instructions direct the one or more processors to identify user-actions previously taken by the user in response to the occurrence of the user-action associated with the given item of the given sub-menu of the sub-menus.

6. The computer apparatus of claim 1 wherein to identify the set of user-actions likely to occur next based on the identity of the user-action, the program instructions direct the one or more processors to identify the set of user-actions likely to occur next based on a sequence of identified user-actions.

7. The computer apparatus of claim 1 wherein to identify the subset of the menu items corresponding to the set of the user-actions likely to occur next, the program instructions direct the one or more processors to map the user-actions likely to occur next to the subset of menu items using a table associating each user-action to a menu item.

8. The computer apparatus of claim 1 wherein the program instructions further direct the one or more processors to track user-actions associated with given items of given sub-menus in a cloud-based data repository to be ingested by a machine learning system to identify the set of user-actions likely to occur next based on the identity of the user-action.

9. A method comprising:
displaying a user interface to the application, wherein the user interface comprises menu items displayed in sub-menus of a menu;
in response to an occurrence of a user-action associated with a given item of a given sub-menu of the sub-menus, identifying a set of user-actions likely to occur next based on an identity of the user-action;
identifying a subset of the menu items corresponding to the set of the user-actions likely to occur next; and
displaying the subset of the menu items in the user interface.

10. The method of claim 9 wherein the subset of the menu items is displayed in a recommendation menu that differs from the sub-menus of the menu.

11. The method of claim 9 wherein each menu item of the subset of the menu items is displayed in an associated sub-menu of the menu.

12. The method of claim 9 wherein to identify the set of user-actions likely to occur next based on the identity of the user-action, the program instructions direct the one or more processors to identify user-actions previously taken by other users in response to the occurrence of the user-action associated with the given item of the given sub-menu of the sub-menus.

13. The method of claim 9 wherein to identify the set of user-actions likely to occur next based on the identity of the user-action, the program instructions direct the one or more processors to identify user-actions previously taken by the user in response to the occurrence of the user-action associated with the given item of the given sub-menu of the sub-menus.

14. The method of claim 9 wherein to identify the set of user-actions likely to occur next based on the identity of the user-action, the program instructions direct the one or more processors to identify the set of user-actions likely to occur next based on a sequence of identified user-actions.

15. The method of claim 9 wherein to identify the subset of the menu items corresponding to the set of the user-actions likely to occur next, the program instructions direct the one or more processors to map the user-actions likely to occur next to the subset of menu items using a table associating each user-action to a menu item.

16. The method of claim 9 wherein the program instructions direct the one or more processors to track user-actions associated with given items of given sub-menus in a cloud-based data repository to be ingested by a machine learning system to identify the set of user-actions likely to occur next based on the identity of the user-action.

17. One or more computer readable storage media having program instructions stored thereon, wherein the program instructions, when executed by a processing system, direct the processing system to at least:
display a user interface to the application, wherein the user interface comprises menu items displayed in sub-menus of a menu;
in response to an occurrence of a user-action associated with a given item of a given sub-menu of the sub-menus, identify a set of user-actions likely to occur next based on an identity of the user-action;
identify a subset of the menu items corresponding to the set of the user-actions likely to occur next; and
display the subset of the menu items in the user interface.

18. The one or more computer readable storage media of claim 17 wherein the subset of the menu items is displayed in a recommendation menu that differs from the sub-menus of the menu.

19. The one or more computer readable storage media of claim 17 wherein to identify the set of user-actions likely to occur next based on the identity of the user-action, the program instructions direct the one or more processors to identify user-actions taken by at least one of the user or other users in response to the occurrence of the user-action associated with the given item of the given sub-menu of the sub-menus.

20. The one or more computer readable storage media of claim 17 the program instructions direct the one or more processors to track user-actions associated with given items of given sub-menus in a cloud-based data repository to be ingested by a machine learning system to identify the set of user-actions likely to occur next based on the identity of the user-action.
